(19) United States
(12) Patent Application Publication
(10) Pub. No.: US 2014/0345798 A1
(43) Pub. Date: Nov. 27, 2014

(54) RE-USABLE UV CURING INSERT FOR MACHINING THIN WALLED CONSUMER ELECTRONIC SYSTEMS

(71) Applicant: Apple Inc., Cupertino, CA (US)

(72) Inventors: Charles H. WERNER, JR., San Jose, CA (US); Derrick T. JUE, San Francisco, CA (US); Hilbert T. KWAN, San Jose, CA (US)

(21) Appl. No.: 14/255,448

(22) Filed: Apr. 17, 2014

Related U.S. Application Data
(60) Provisional application No. 61/825,961, filed on May 21, 2013.

(51) Int. Cl. B23Q 3/00

(52) U.S. Cl. CPC B23Q 3/005
USPC 156/275.7; 156/379.6; 269/37

(57) ABSTRACT

Manufacturing techniques are provided herein. In one embodiment, a reusable insert is used within a pocket disposed within a thin walled enclosure to prevent deformation of the thin walled enclosure during a machining operation. The insert includes a body including a transparent material and having a size and shape in accordance with the pocket disposed within the thin walled enclosure, and at least one channel having a first opening at a first surface of the body and a second opening at a second surface of the body. Related apparatuses and methods are also provided.

### CROSS-REFERENCE TO RELATED APPLICATIONS

The present application claims the benefit of U.S. Provisional Application No. 61/825,961, entitled “RE-USABLE UV CURING INSERT FOR MACHINING THIN WALLED CONSUMER ELECTRONIC SYSTEMS” filed May 21, 2013, the contents of which are incorporated herein by reference in their entirety for all purposes.

### FIELD

The described embodiments relate generally to methods for machining a thin walled enclosure. In particular, techniques for machining a thin wall of a metal enclosure used for a consumer electronic product are disclosed.

### BACKGROUND

The quest for production of smaller, lighter, and cheaper devices is ongoing. In this regard, by way of example, it may be desirable to produce housings for devices such as computing devices that are relatively thin in order to provide benefits such as reduced material usage, reduced size, reduced weight, and the ability to include additional electronic components. However, the production of thin-walled housings can present certain challenges.

For example, harmonics occurring during machining processes conducted on relatively thin components and stress relief occurring in the material after machining is complete can cause the material to distort and fail to meet flatness requirements or other shape tolerances. Further, the resulting surface roughness or finish can differ from the specifications. Accordingly, if the component is salvageable, extended finishing operations can be required causing cycle times for production to increase, thereby directly increasing productions costs.

### SUMMARY

Embodiments of the present disclosure relate to use of a support material as a temporary fixture to support a component during manufacturing. In one embodiment, a method for manufacturing a thin-walled enclosure using an insert is set forth. The method can include a step of adhering the surface of the insert to one of surfaces of the thin-walled enclosure by moving a UV curable adhesive through the channel from the UV curable adhesive supply port to a surface of the insert in place between two surfaces of a thin-walled enclosure. The insert can include an ultra-violet light (“UV”) port, a UV curable adhesive supply port, and a channel through a portion of the insert. Further, the method can include curing the UV curable adhesive by exposing the UV curable adhesive to UV provided by the UV port.

In another embodiment, an optically clear insert is set forth as having an insert body and an ultra-violet light (“UV”) port on a first surface of the insert body configured to receive a UV light source. The insert can further include an adhesive supply port on the first surface of the insert body configured to receive UV curable adhesive. Additionally, the insert can include a channel through a portion of the insert body, configured to receive UV curable adhesive from the adhesive supply port.

In yet another embodiment, a system for manufacturing an enclosure using an acrylic insert is set forth. The acrylic insert of the system can include an ultra-violet (“UV”) light port, a UV curable adhesive supply port, and a channel through a portion of the acrylic insert. Additionally, the system can include a UV source coupled to the UV port of the acrylic insert for emitting UV light through the acrylic insert. In this way, the UV can cure a UV curable adhesive adhered to both the acrylic insert and enclosure.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, assemblies, methods, and systems. These drawings in no way limit any changes in form and detail that may be made to the disclosure by one skilled in the art without departing from the spirit and scope of the disclosure.

FIG. 1 illustrates a perspective view of the insert prior to placement within a pocket of a thin-walled enclosure in accordance with some of the embodiments;

FIG. 2 illustrates a perspective view of the insert prior to placement within a pocket of a thin-walled enclosure in accordance with some of the embodiments;

FIG. 3 illustrates a perspective view of the insert prior to placement within a pocket of a thin-walled enclosure in accordance with some of the embodiments;

FIG. 4 illustrates a perspective view of the insert prior to placement within a pocket of a thin-walled enclosure in accordance with some of the embodiments;

FIG. 5 shows placement of insert prior to placement within a pocket of a thin walled enclosure;

FIG. 6 shows insert secured to the thin walled enclosure;

FIG. 7 shows a flowchart that details a process in accordance with the described embodiments.

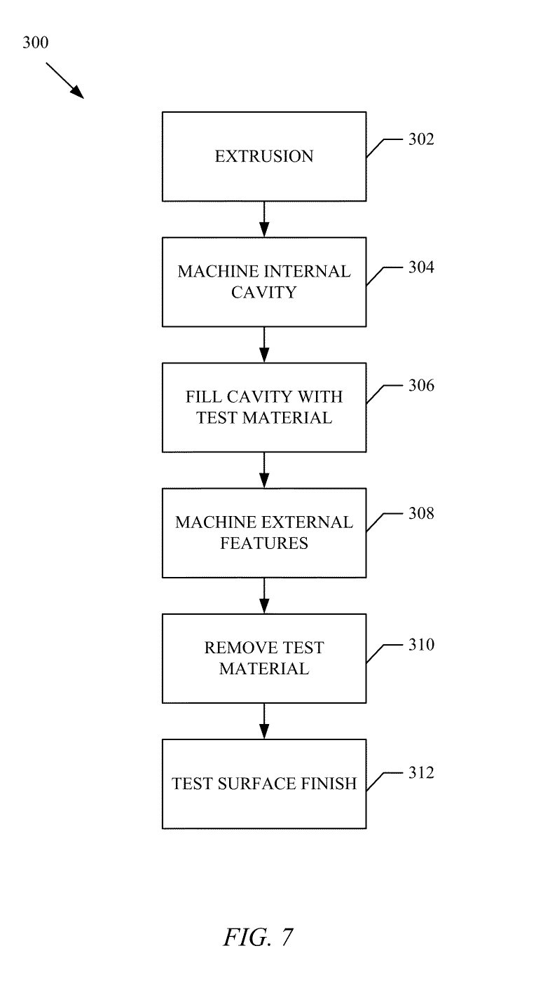

### DETAILED DESCRIPTION

Representative applications of systems, apparatuses, and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

It is advantageous for portable computers to be as slim and light as possible to facilitate their mobility. For this reason, the internal space allocated to the operational components can be critical to the performance of the portable computer. Accordingly, reducing the thickness of a housing used to enclose and support the operational components can greatly enhance the number and packing density of the operational components. In particular, a housing formed of aluminum can be formed having a nominal wall thickness of a few millimeters to tenths of millimeters or more. An aluminum wall having such a nominal thickness can be prone to damage. In particular, non-elastic deformation (e.g., dents) can be easily induced in the aluminum enclosure during conventional machining operations (such as computer numerical control or “CNC”). In order to preserve the structural integrity and cosmetic appearance of the aluminum housing during a machining operation, an insert having suitable dimensions can be used.

Techniques and embodiments are set forth herein for using UV curing during a machining process. In a particular embodiment, an insert can be formed of UV or optically transparent material (acrylic, epoxy, etc.) and formed into a block or other suitable shape. The insert can be placed within a thin walled enclosure in such a way so as to prevent non-elastic deformation of the thin walls of the enclosure during a machining operation. In some embodiments, the acrylic block can have a 2-5 millimeter wall gap for adhesive bonding within deep cavities. The acrylic block can be an over-molded UV light source allowing UV light to penetrate in deep cavities. In some embodiments, the UV light source is a wand shape and can therefore serve to assist in aligning the acrylic block in the center of a cavity, for optimal placement of the adhesive.

In order to prevent movement of the block until such time as the block can be removed, the block includes a number of ports configured to provide a conduit for the application of a UV curable adhesive used to secure the insert into the enclosure at a pre-defined location. The nature of the UV curable adhesive can be such that the acrylic block can be easily removed by exposing the UV curable adhesive to an elevated temperature (such as 100° F.). For example, in one embodiment, the post processed enclosure, including the acrylic inserts adhered to an interior space of the enclosure, can be exposed to 100° F. water. This results in the reduction of adhesion between the acrylic block and an interior surface of the enclosure thereby facilitating easy removal of the acrylic blocks in preparation for additional processing (such as anodization in the case of an aluminum housing).

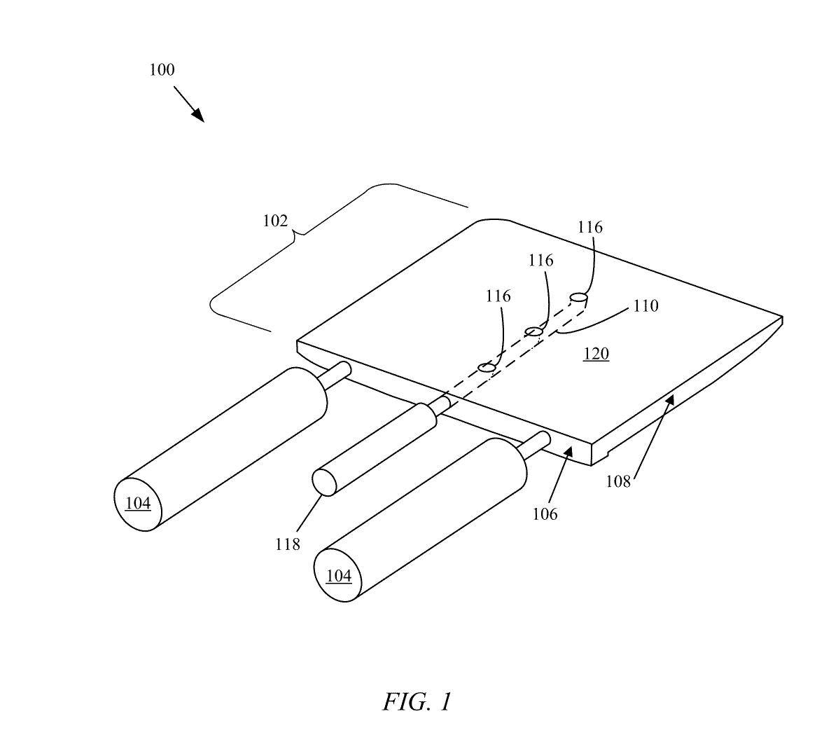

FIGS. 1-4 show various views of reusable insert 100 in accordance with the described embodiments. FIG. 1 shows a top perspective view of insert 100 in accordance with the described embodiments. Insert 100 can include body 102 having a size and shape in accordance with a pocket formed within a thin walled enclosure. Accordingly, body 102 can have a cross section that conforms to a corresponding cross section of the pocket. Insert 100 can also include adhesive port 118 used to inject UV curable adhesive into body 102. In one embodiment, the UV curable adhesive can be injected under pressure into adhesive port 118 and pass through channels 110 in body 102, from first surface 106 and out of openings 116 on third surface 120. The body 102 of insert 100 can be formed in such a way that UV light can pass from first surface 106, through body 102, and exit through all surfaces of insert 100. In some embodiments, portions of body 102 can be configured to act as light guides that allow passage of UV light from first surface 106 to second surface 108. In this way, the UV light incident on first surface 106 can be directed to those areas of second surface 108 that require sufficient UV light to cure an associated amount of UV curable adhesive. Moreover, black tape or another light-blocking mechanism can be placed on various portions of the surfaces of the insert 100 to prevent UV light from exiting the insert 100 at those portions. Additionally, the light sources can be removable or permanently attached to insert 100.

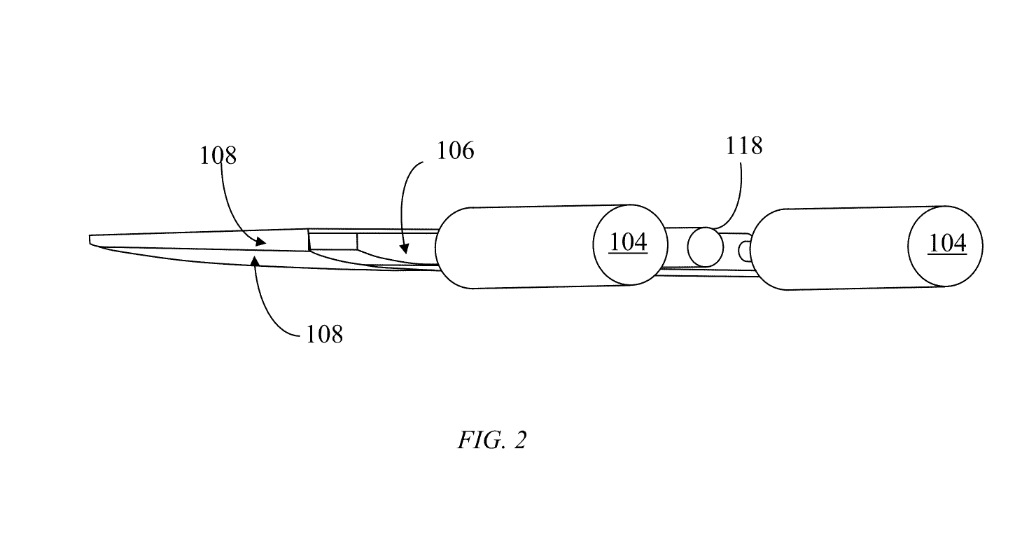

FIG. 2 shows another view of insert 100 illustrating more clearly how the shape of body 102 conforms to that of the pocket into which it is inserted. In particular, the shape of body 102 can conform to an interior surface of the enclosure in which it is inserted. In some cases, the shape of body 102 can accommodate internal features disposed at the interior surface of the enclosure.

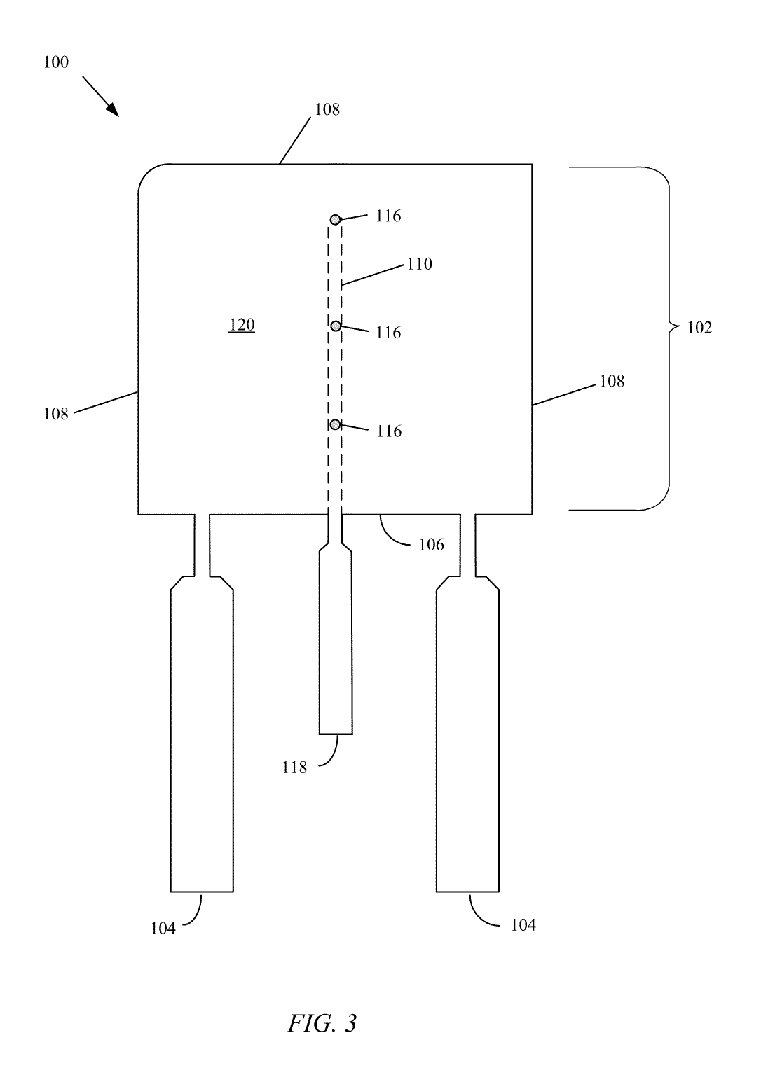

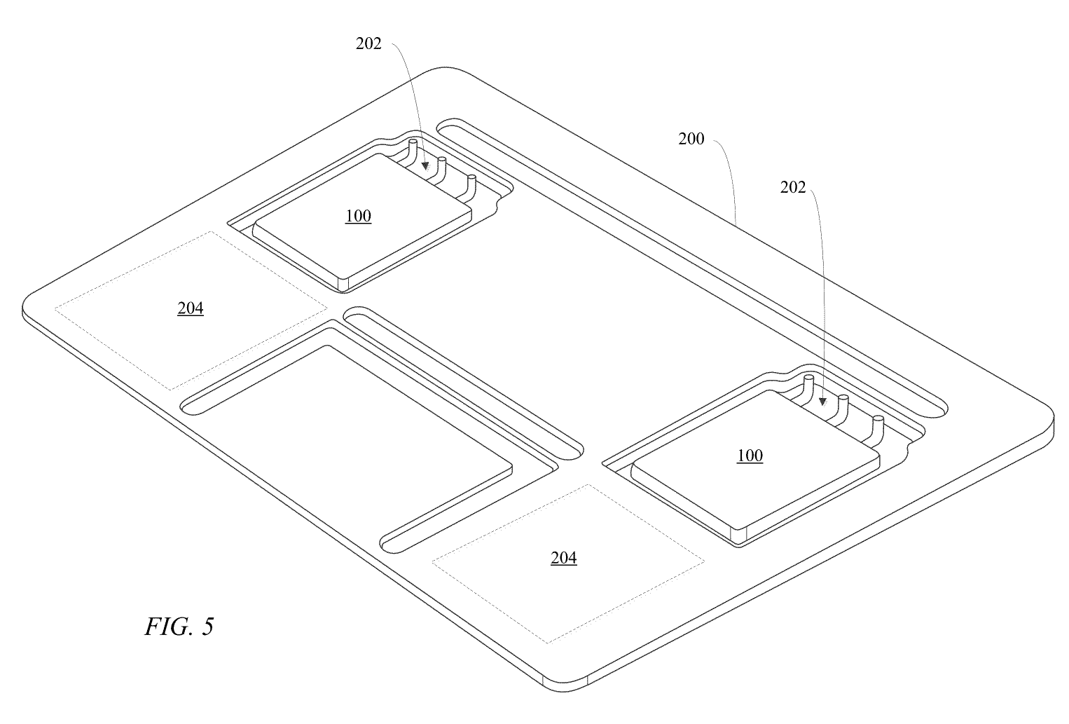

FIG. 3 shows a top view of an embodiment where a channel 110 acts as a path for adhesive to be placed onto third surface 120. Once inserted into a recess of an enclosure (see FIG. 5), adhesive is forced from adhesive port 118 through first surface 106 and channel 110. Upon moving through channel 110, the adhesive protrudes out from openings 116. The adhesive can then evenly spreads onto third surface 120. UV light is directed through UV light ports 104, into surface 106, and exits the insert 100 from all surfaces of the insert 100. Any UV light that penetrates the adhesive on third surface 120 will be cured.

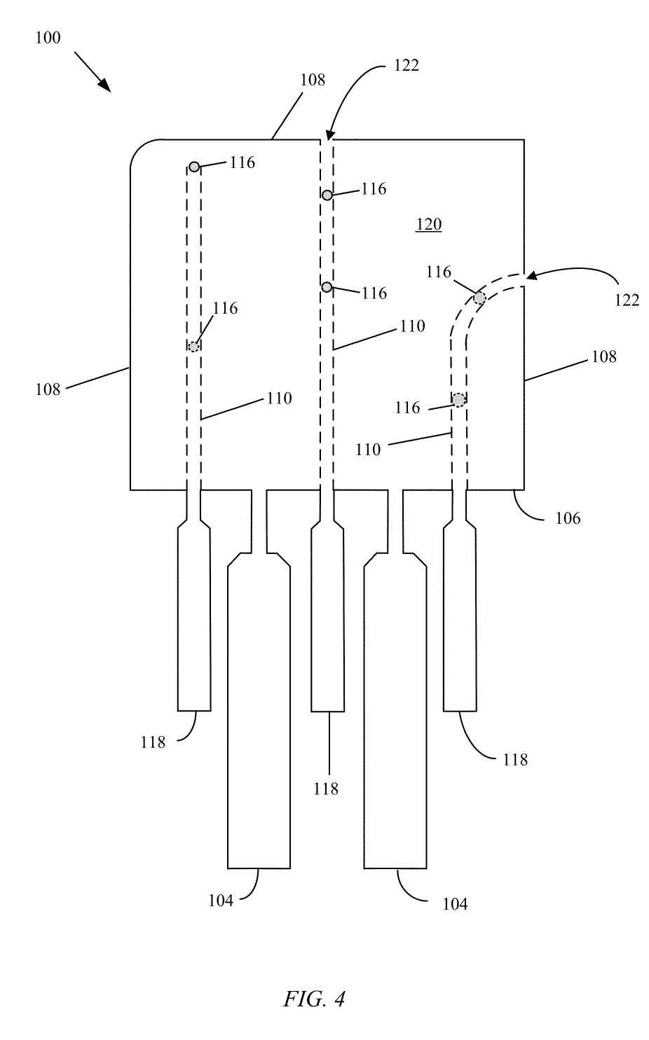

FIG. 4 illustrates a top view including a variety of arrangements for insert 100. Specifically, FIG. 4 shows a variety of arrangements for channels 110, adhesive ports 118, and UV light ports 104. Channels 110 can be configured between first surface 106 and exit at either: second opening 122 at second surface 108, openings 116 on third surface 120, and/or a surface on a side of the insert 100 opposing the third surface 120. UV curable adhesive can be injected under pressure if necessary at port 118 and passed through first surface 106 through channels 110 to second opening 122 at second surface 108. The UV curable adhesive can pass through opening 116 for deposition between second surface 108 and an interior surface of a pocket disposed within the thin walled enclosure (see FIG. 5). Openings 116 illustrated as solid lines are on surface 120 and openings 116 having dotted or hidden lines are on a surface opposing surface 120. In some embodiments channels 110 can be curved (as illustrated in FIG. 4) or diagonal with respect to first surface 106 (not shown). The openings 116 can be approximately 1 millimeter in diameter, or another suitable diameter for a given manufacturing process depending on the areas deemed most suitable for a UV curable adhesive to be place. Furthermore, the openings 116 can be arranged in rows, columns, circles, squares, triangles, or any other suitable arrangement for a particular manufacturing process.

FIG. 5 shows enclosure 200 having recess 202 in which insert 100 is placed prior to insertion within pocket 204. In the described embodiments, enclosure 200 can include a number of pockets that are only readily accessible by way of recess 202. In particular, insert 100 can be placed within pocket 204 only by sliding insert 100 laterally from recess 202 to a resting position within pocket 204 as shown in FIG. 5. Once insert 100 is placed in the resting position, UV curable adhesive is injected into adhesive ports 118, passing through channels 110 to exit at openings 116 (shown in FIGS. 3-4), and deposited between an interior surface of enclosure 200 in pocket 204.

Once the UV curable adhesive is deposited on the interior surface of the enclosure, UV light can be used to cure the UV curable adhesive. In one embodiment, the UV light can be incident upon first surface 106 and passes through body 102. In one embodiment, body 102 can be formed of UV transparent material. Body 102 can also be formed to include light guides that direct the UV light incident on first surface 106 to selected areas of second surface 108. In this way, selected portions of the UV curable adhesive deposited between insert 100 and the interior of enclosure 200 at pocket 204 can be cured. The UV light applied can be in the form of one or more bursts having specific time periods. In one embodiment the burst of UV light used to cure is 17 seconds. In other embodiments, the time period can longer or shorter. Moreover, adjusting an iris opening of the UV light source can change the intensity of the UV light for different manufacturing processes. In some embodiments, an iris opening of 50% is used for curing the adhesive.

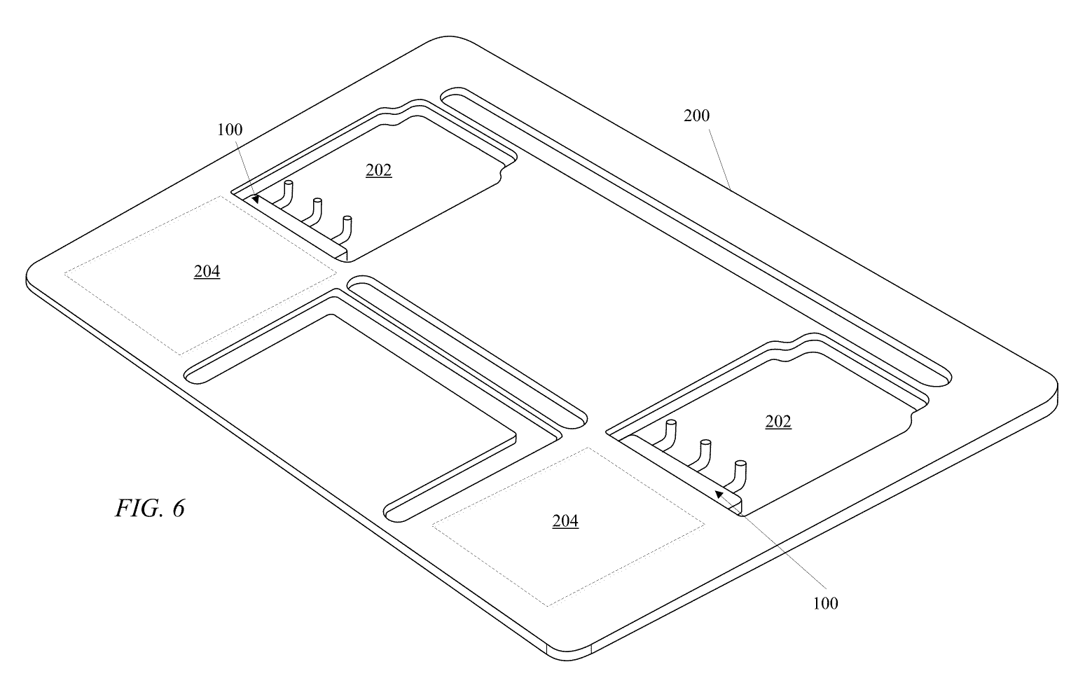

FIG. 6 illustrates insert 100 inside of pocket 204 and secured to enclosure 200. Once insert 100 has been secured to enclosure 200, operations used to further form enclosure 200 can take place. For example, a CNC operation can be performed without damaging the thin wall of enclosure 200 since insert 100 can provide the requisite structural support for pocket 204. In one embodiment, insert 100 can be removed by exposing the cured UV adhesive to an elevated temperature, for example, by immersing enclosure 200 into a warm water bath at approximately 100° F. followed by a simple lateral movement of insert 100 to break the weakened UV adhesive bond.

FIG. 6 shows a flowchart that details process 300 in accordance with the described embodiments. Process 300 can be carried out by performing at least the following operations. At 302, extruding a thin walled enclosure followed at 304 by machining an internal cavity, or pocket. A reusable insert is then placed within and secured to an interior of the enclosure at the cavity, or pocket, at 306. At 308, external features are machined, the insert providing structural support for the enclosure during the machining operations. At 310, the insert is removed from the enclosure. In one embodiment, the reusable insert is heated to a temperature that weakens the bond between the insert and the enclosure but not high enough to damage the insert. For example, when the insert is formed of acrylic and secured to the enclosure using UV curable adhesive, the enclosure can be immersed in a warm water bath at about 100° F. At 312, the surface finish of the enclosure can be tested for conformance to appropriate specifications. Other steps can be performed on the test material after removal from the enclosure including cleaning and sand blasting. Adhesive should be removed from the enclosure and the insert 100 so that the insert 100 can be used in future machining processes.

The various aspects, embodiments, implementations or features of the described embodiments can be used separately or in any combination. The advantages of the invention are numerous. Different aspects, embodiments or implementations can yield one or more of the following advantages. One advantage of the invention is that a thin walled enclosure can be machined without damaging the enclosure, the insert providing structural support.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for manufacturing a thin-walled enclosure using an insert, the method comprising:
adhering a surface of the insert to a surface of the thin-walled enclosure by moving a UV curable adhesive through a channel of the insert from a UV curable adhesive supply port to the surface of the insert in place between two surfaces of the thin-walled enclosure, wherein the insert includes an ultra-violet light (“UV”) port, a UV curable adhesive supply port, and a channel through a portion of the insert; and
curing the UV curable adhesive by exposing the UV curable adhesive to UV provided by the UV port.

2. The method of claim 1, wherein placing the insert between two surfaces of the thin-walled enclosure is such that a 2-5 millimeter gap is created between the insert and the thin-walled enclosure.

3. The method of claim 1, wherein the insert is formed of optically transmissive acrylic material, and curing the UV curable adhesive includes allowing UV light to penetrate the surface of the insert.

4. The method of claim 1, wherein moving the UV curable adhesive through the channel includes allowing the adhesive to exit from a plurality of openings on the surface of the insert.

5. The method of claim 1, wherein curing the UV curable adhesive includes directing the UV to the UV curable adhesive using light guides.

6. The method of claim 1, further comprising: machining a portion of the thin-walled enclosure after the UV curable adhesive is cured by the UV.

7. The method of claim 1, wherein curing the UV curable adhesive includes fixing an amount of time that UV is emitted from the UV port.

8. An optically clear insert, comprising:
an insert body formed of optically clear material;
an ultra-violet light (“UV”) port on a first surface of the insert body configured to receive a UV source;
an adhesive supply port on the first surface of the insert body configured to receive UV curable adhesive; and
a channel through a portion of the insert body, configured to receive UV curable adhesive from the adhesive supply port.

9. The optically clear insert of claim 8, further comprising:
a second surface of the insert body, wherein the second surface includes a plurality of openings, wherein each of the openings of the plurality of openings extend from the channel.

10. The optically clear insert of claim 9, wherein the plurality of openings form a single linear row on the second surface.

11. The optically clear insert of claim 8, wherein the UV curable adhesive supply port is configured between a plurality of UV ports on the first surface.

12. The optically clear insert of claim 8, wherein the optically clear material is acrylic.

13. A system for manufacturing an enclosure using an acrylic insert, the system comprising:
the acrylic insert comprising an ultra-violet light (“UV”) port, a UV curable adhesive supply port, and a channel through a portion of the acrylic insert; and
a UV source coupled to the UV port of the acrylic insert for emitting UV light through the acrylic insert and cure a UV curable adhesive that can be adhered to both the acrylic insert and enclosure.

14. The system of claim 13, further comprising:
a UV curable adhesive supply connected to a surface of the acrylic insert.

15. The system of claim 13, further comprising:
the acrylic insert having a thickness that is 2-5 millimeters less than a width of a plurality of walls of the enclosure that the acrylic insert is configured to be adhered to.

16. The system of claim 13, wherein the channel is a cavity between a plurality of openings on a surface of the acrylic insert and the adhesive supply port.

17. The system of claim 13, wherein the UV curable adhesive is cured for a fixed amount of time.

18. The system of claim 13, wherein moving the UV curable adhesive through the channel includes allowing the adhesive to exit from a plurality of openings on a surface of the acrylic insert.

19. The system of claim 18, wherein the plurality of openings are arranged in a plurality of linear rows.

20. The system of claim 13, wherein the UV source includes an adjustable iris opening.
